(19) United States
(12) Patent Application Publication
(10) Pub. No.: US 2026/0302886 A1
(43) Pub. Date: Oct. 1, 2026

(54) DEVICE FOR SUPPLYING ELECTRICAL ENERGY TO A VEHICLE OF AN AMUSEMENT RIDE, IN PARTICULAR OF A ROLLER COASTER, AND VEHICLE AND AMUSEMENT RIDE

(71) Applicant: MACK RIDES GMBH & CO. KG, Waldkirch (DE)

(72) Inventor: Andreas FRIEDBERGER, Waldkirch (DE)

(21) Appl. No.: 19/476,407

(22) PCT Filed: Dec. 19, 2023
(86) PCT No.: PCT/EP2023/086635

§ 371 Date: Oct. 17, 2025

(30) Foreign Application Priority Data
Apr. 18, 2023 (DE) 10 2023 109 699.0

(51) Int. Cl. H02K 7/18; A63G 7/00; B61K 13/00; H02K 7/116; H02K 11/00

(52) U.S. Cl. CPC H02K 7/1846; A63G 7/00; B61K 13/00; H02K 7/116; H02K 11/0094

(57) ABSTRACT

Device (10) for supplying electrical energy to a vehicle (11) of an amusement ride, in particular a roller coaster, comprising
a generator (12),
a mechanical transmission section (14) arranged on the generator,
a wheel couplable to the mechanical transmission section (14), and
at least one capacitor chargeable by means of the generator (12), and a vehicle (11) having such a device,
   and an amusement ride having such a vehicle (11).

The present invention relates to a device for supplying electrical energy to a vehicle of an amusement ride, in particular a roller coaster, a vehicle of an amusement ride having such a device, as well as an amusement ride having such a vehicle.

Amusement rides are known from the prior art in various configurations and are provided as stationary or semi-stationary installations or attractions, in particular in amusement parks, for the leisure entertainment of passengers. Generic amusement rides can be, for example, water rides, roller coasters, dark rides, carousels, spin amusement rides, or the like, which have at least one passenger accommodation in which at least one passenger can travel along a route. The at least one passenger accommodation can be arranged, for example, on a vehicle or on a movable frame.

It has been shown that supplying the vehicles with electrical energy can be complex. On the one hand, power storage devices such as rechargeable batteries must be carried, which on the one side significantly weigh down vehicles. On the other hand, the power storage devices must be charged regularly, for which the vehicles must, for example, be taken to a maintenance area. This particularly affects passively driven vehicles, which is to say, vehicles that do not have their own active drive. This is the case, for example, with roller coaster vehicles that are accelerated by gravity (so-called lift hill coasters) or by means of a catapult start (so-called launched coasters).

The invention is therefore based on the task of providing a device for supplying electrical energy to a vehicle of an amusement ride, in particular a roller coaster, which eliminates the disadvantages known from the prior art in a practical manner and is also easy to manufacture. The proposed device should, moreover, be able to ensure a self-sufficient energy supply, in particular for a vehicle of an amusement ride. The invention is also based on the task of providing a corresponding vehicle and a corresponding amusement ride.

The task is solved according to the invention by a device with the features of patent claim 1, a vehicle with the features of patent claim 10, and an amusement ride with the features of patent claim 13.

Advantageous configurations and further developments of the invention are specified in the dependent claims.

A device according to the invention for supplying electrical energy to a vehicle of an amusement ride, in particular a roller coaster, comprises a generator, a mechanical transmission section arranged on the generator, a wheel couplable to the mechanical transmission section, as well as at least one capacitor chargeable by means of the generator. Using such an arrangement, the generator can be mechanically driven via the mechanical transmission section by the travel movement of the vehicle, so that the capacitor can be charged by the travel movement of the vehicle. Preferably, for this purpose, the rotation of the wheel is couplable to the travel movement of the vehicle. The vehicle can thereby preferably be supplied with energy during its use in the amusement ride without the need for a mains connection or the need to carry large and heavy rechargeable batteries. Downtime for charging batteries can likewise be eliminated. In addition, the device according to the invention can be manufactured and installed at low cost. In particular, the retrofitting of older vehicles is possible with relatively little effort.

In one embodiment of the invention, the generator is arranged in a hub of the wheel. In this way, an arrangement with a low space requirement can be realized. Such an arrangement is particularly suitable for vehicles that are designed with a corresponding device from the outset.

The mechanical transmission section is particularly preferably formed by the hub of the wheel. Such arrangements are known, for example, from hub dynamos on bicycles. The device can thus be integrated into the vehicle with particularly little engineering effort.

For coupling with the wheel, the mechanical transmission section may comprise a receiving wheel that can be arranged on the wheel and/or a shaft coupling that can be arranged on the wheel. A device designed in this way may be suitable as a retrofit solution for existing vehicles, in particular due to the relatively limited installation effort involved. The receiving wheel can be arranged on a wheel body, in particular a running surface of the wheel body, or a wheel shaft of the wheel. The shaft coupling can preferably be arranged on the wheel shaft. The operative connection between the wheel on the one hand and the receiving wheel and/or the shaft coupling on the other hand can be designed to be form-fitting and/or friction-fitting. To provide a form-fit connection, the receiving wheel can, for example, be designed as a gear wheel and the wheel body and/or the wheel shaft can have corresponding intermeshing structures. To provide a friction-fit connection, the receiving wheel can, for example, be designed as a friction wheel and/or the shaft coupling can be designed as a friction coupling.

The wheel of the device is preferably formed by a running wheel of the vehicle. In this way, existing components and/or assemblies of the vehicle can be used for implementation of the device. Here and in the following, the running wheel is preferably understood to be a wheel of the vehicle that establishes contact between the vehicle and the environment, which is to say, in particular, the rest of the amusement ride, relative to which the vehicle is movable. The running wheel substantially serves to transmit the vehicle forces, in particular braking, acceleration, and/or lateral forces, to the environment, in particular to a track. The running wheel of a roller coaster vehicle, for example, preferably establishes contact between the roller coaster vehicle and the track of the roller coaster, which is often designed as a rail system, and thus transmits the braking, acceleration, and/or lateral forces acting on the roller coaster vehicle.

The mechanical transmission section may have a switchable coupling. The power supply provided by the generator can thereby be mechanically activated or alternatively deactivated. In particular, the switchable coupling may be formed by the shaft coupling. Alternatively, the switchable coupling may be formed by the receiving wheel being designed to be removable from the wheel body or alternatively the wheel shaft.

The mechanical transmission section may, moreover, comprise a gear unit for converting torque and rotational speed. This allows the rotational speed provided by the wheel and the torque provided by the wheel to be adapted to the rotational speed or alternatively the

In a preferred embodiment of the invention, the device comprises a control unit that is designed to control a charging process and/or a discharging process of the at least one capacitor. In this manner, a demand-oriented and, if necessary, continuous and/or constant power supply can be provided. The device may comprise a first control unit for controlling the charging process of the capacitor and/or a second control unit for controlling the discharging process of the capacitor. The first control unit is preferably arranged on the electrical path between the generator and the capacitor. The second control unit is preferably arranged on the electrical path between the capacitor and a consumer.

In a further development of the invention, the at least one capacitor is designed as a supercapacitor. The advantages of the device, such as its low mass and minimal installation space requirements, with contemporaneous high performance, can thereby be improved. Preferably, such a capacitor can be charged and/or discharged within a few seconds, so that a device designed in this way can offer strong dynamics, particularly in terms of time.

The at least one supercapacitor can also be referred to as a “supercap” for short or in German “Superkondensator”, or even an ultracapacitor. Supercapacitors are preferably used because they have an extremely high power density compared to other types of energy storage devices such as rechargeable batteries, which is why they can be charged and discharged quickly. It has proven, in particular, advantageous that capacitors in general and supercapacitors in particular have a significantly longer service life than the aforementioned rechargeable batteries and can therefore withstand a significantly larger number of charging cycles without loss of performance.

A vehicle according to the invention for an amusement ride, in particular a roller coaster, comprises the device described above.

The vehicle may comprise at least one electrical consumer that is in electrical operative connection with the generator. In this way, the at least one electrical consumer can be supplied with electrical energy. The at least one capacitor preferably serves in particular to compensate for differences between the electrical energy provided by the generator and the energy required by the at least one consumer. In this respect, the at least one capacitor can serve as a buffer storage device. The at least one consumer can comprise, among other things, a lighting device and/or a communication means, such as a radio unit, of the vehicle. The at least one consumer may, in particular, comprise a communication device if the amusement ride is designed as a so-called virtual reality amusement ride, which provides a user of the amusement ride with a virtual reality during the ride. Such virtual reality amusement rides are regularly equipped with a virtual reality module, which comprises, for example, virtual reality glasses. By means of the communication means, the virtual reality provided to the user of the amusement ride can be adapted to the temporal and spatial constraints of the amusement ride.

Preferably, the vehicle is a passively driven vehicle. Here and in the following, a passively driven vehicle is preferably understood to be a vehicle that does not have its own drive system. Such passively driven vehicles can, for example, be driven by gravitational forces, as in so-called lift hill coasters, or by a catapult start, as in so-called launched coasters. In passively driven vehicles, the provision of the device described above eliminates the need for an external power supply for the vehicle.

An amusement ride according to the invention, in particular a roller coaster, comprises a vehicle as described above.

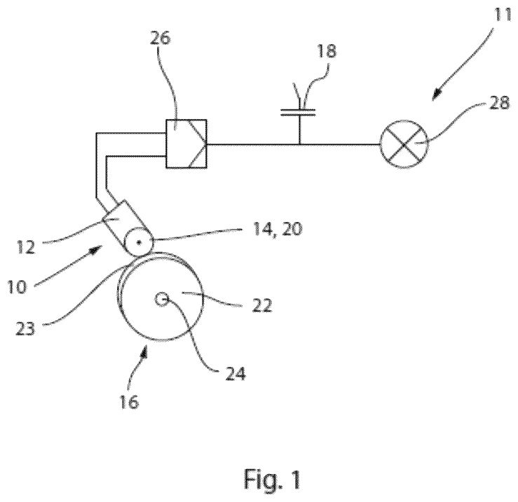

The following FIG. 1 shows a schematic section of a vehicle 11 of an amusement ride, in particular a roller coaster, with a likewise schematically represented example of a device 10 according to the invention for supplying electrical energy to the vehicle 11. The device 10 comprises a generator 12, a mechanical transmission section 14 arranged on the generator 12, as well as a running wheel 16 of the vehicle 11, which is couplable to the mechanical transmission section 14. The device 10, moreover, comprises several supercapacitors 18 chargeable by means of the generator 12, which are shown schematically in their entirety in FIG. 1 with a capacitor symbol. The supercapacitors 18 have high performance and strong dynamics. The vehicle 11 can thus be supplied with energy, preferably during its use in the amusement ride, without the need for a mains connection or the need to carry large and heavy rechargeable batteries.

In the embodiment example shown in FIG. 1, the mechanical transmission section 14 comprises a receiving wheel 20 that can be arranged on the running wheel 16. The embodiment example of the device 10 shown is therefore particularly suitable as a retrofit solution for existing vehicles. The receiving wheel 20 can preferably be arranged on a wheel body 22, in particular on a running surface 23 of the wheel body 22, or on a wheel shaft 24 of the running wheel 16. The operative connection between the running wheel 16 on the one hand and the receiving wheel 20 on the other hand can be designed to be form-fitting and/or friction-fitting. To provide a form-fit connection, the receiving wheel 20 can, for example, be designed as a gear wheel and the wheel body 22 and/or the wheel shaft 24 can have corresponding intermeshing structures. To provide a friction-fit connection, the receiving wheel 20 can, for example, be designed as a friction wheel.

The mechanical transmission section 14 may have a switchable coupling, for example, wherein the receiving wheel 20 is designed so that it can be lifted off the wheel body 22 or the wheel shaft 24. The power supply provided by the generator 12 can thereby be mechanically activated or alternatively deactivated.

The embodiment example shown in FIG. 1 also features a control unit 26 that is designed to control the charging process of the supercapacitors 18. The control unit 26 is located on the electrical path between the generator 12 and the supercapacitors 18.

The schematic diagram of the vehicle 11 shown in FIG. 1 shows at least one electrical consumer 28, that is likewise shown schematically, which comprises an electrical operative connection to the generator 12 and the supercapacitors 18. In this way, the at least one electrical consumer 28 can be supplied with electrical energy. The supercapacitors 18 thereby serve, in particular, to compensate for differences between the electrical energy provided by the generator 12 and the energy required by the at least one consumer 28, such that the supercapacitors 18 serve as buffer storage device. The at least one consumer 28 may comprise, for example, a lighting device and/or a means of communication of the vehicle 11.

The vehicle 11 shown schematically in FIG. 1 is preferably a passively driven vehicle. Accordingly, the running wheel 16 preferably does not have its own drive system.

### REFERENCE LIST

10 device
11 vehicle
12 generator
14 mechanical transmission section
16 running wheel
18 supercapacitors
20 receiving wheel
22 wheel body
23 running surface
24 wheel shaft
26 control unit
28 electrical consumer

1. Device (10) for supplying electrical energy to a vehicle (11) of an amusement ride, in particular a roller coaster, comprising
a generator (12),
a mechanical transmission section (14) arranged on the generator,
a wheel couplable to the mechanical transmission section (14), and
at least one capacitor chargeable by means of the generator (12).

2. Device according to claim 1
characterized in that
the generator (12) is arranged in a hub of the wheel.

3. Device according to claim 2
characterized in that
the mechanical transmission section (14) is formed by the hub of the wheel.

4. Device according to claim 1
characterized in that
for coupling with the wheel, the mechanical transmission section (14) comprises a receiving wheel (20) that can be arranged on the wheel and/or a shaft coupling that can be arranged on the wheel.

5. Device according to claim 1, characterized in that
the wheel is formed by a running wheel (16) of the vehicle.

6. Device according to claim 1, characterized in that
the mechanical transmission section (14) comprises a switchable coupling.

7. Device according to claim 1, characterized in that
the mechanical transmission section (14) comprises a gear unit for converting torque and rotational speed.

8. Device according to claim 1, characterized in that
the device (10) comprises a control unit (26) that is designed to control a charging process and/or a discharging process of the at least one capacitor.

9. Device according to claim 1, characterized in that
the at least one capacitor is designed as a supercapacitor (18).

10. Vehicle (11) for an amusement ride, in particular a roller coaster, with a device (10) according to claim 1.

11. Vehicle according to claim 10,
characterized in that
the vehicle (11) comprises at least one electrical consumer (28) that is in electrical operative connection with the generator (12) and/or the at least one capacitor.

12. Vehicle according to claim 10, characterized in that
the vehicle (11) is a passively driven vehicle.

13. Amusement ride, in particular a roller coaster, with a vehicle (11) according to claim 10.
